(19) United States
(12) Patent Application Publication
(10) Pub. No.: US 2016/0209102 A1
(43) Pub. Date: Jul. 21, 2016

(54) SELF-ADJUSTING DOOR FOR AN APPLIANCE

(71) Applicant: General Electric Company, Schenectady, NY (US)

(72) Inventors: Gopi Krishna Chowdary Vulava, Louisville, KY (US); Dennis John Ruckriegel, Louisville, KY (US); Matthew William Davis, Prospect, KY (US); Anil Challapalli, Louisville, KY (US)

(21) Appl. No.: 14/597,300

(22) Filed: Jan. 15, 2015

(51) Int. Cl. F25D 23/02; E05D 15/00

(52) U.S. Cl. CPC F25D 23/028; E05D 15/00; F25D 2201/10; F25D 2300/00

(57) ABSTRACT

A refrigerator appliance including a cabinet defining a chilled chamber and a first slide assembly is provided. The first slide assembly is mounted to the cabinet at least partially within the chilled chamber. The refrigerator appliance also includes a door with a frame having a first frame member rotatably attached to the first slide assembly at a first pivot joint. The door is rotatable about the lateral direction at the first pivot joint between an inwardly tilted position and an outwardly tilted position. In the inwardly tilted position the door defines an acute angle with the first slide assembly, and in the outwardly tilted position the door defines an obtuse angle with the first slide assembly. Such a configuration may allow the door to form a more complete seal with the cabinet of the refrigerator appliance despite any, e.g., surface variations of the cabinet.

### FIELD OF THE INVENTION

The present subject matter relates generally to appliances, such as refrigerator appliances, and doors for the same.

### BACKGROUND OF THE INVENTION

Generally, refrigerator appliances include a cabinet that defines a chilled chamber for receipt of food items for storage. The refrigerator appliance can also include storage components mounted within the chilled chamber. For example, shelves, drawers, bins, and other components can be mounted within the chilled chamber. Such components can receive food items in order to facilitate storage and/or organization of food items within the chilled chamber. In particular, certain refrigerator appliances include fresh food drawers that are configured for extending the shelf life of fresh food (e.g., vegetables, cheeses, etc.) stored therein.

Refrigerator appliances generally also include a door positioned over the chilled chamber when in the closed position. In order to increase a thermal efficiency of the refrigerator appliance, the door may form a seal with the cabinet of refrigerator appliance around the chilled chamber. In certain refrigerator appliances, the door is attached to the cabinet using one or more slide assemblies such that the door moves in a linear direction away from cabinet to an open position and in the linear direction towards the cabinet to the closed position. The one or more slide assemblies generally constrain the door to moving solely along the linear direction between the open and closed positions.

However, it is possible that the cabinet of the refrigerator appliance may have undesirable surface variations which may make it challenging for the door to form a proper seal with cabinet around chilled chamber. Accordingly, a door assembly for a refrigerator appliance capable of automatically accounting for such surface variations of the refrigerator appliance would be useful. More particularly, a door assembly for a refrigerator appliance capable of forming a seal with the cabinet of the refrigerator appliance despite any surface variations in the cabinet of the refrigerator appliance would be particularly beneficial.

### BRIEF DESCRIPTION OF THE INVENTION

Aspects and advantages of the invention will be set forth in part in the following description, or may be apparent from the description, or may be learned through practice of the invention.

In a first exemplary embodiment, a refrigerator appliance defining a lateral direction is provided. The refrigerator appliance includes a cabinet defining a chilled chamber, a first slide assembly mounted to the cabinet at least partially within the chilled chamber, and a second slide assembly mounted to the cabinet at least partially within the chilled chamber. The second slide assembly is mounted at a position opposite the first slide assembly along the lateral direction. The refrigerator appliance additionally includes a door including a frame having a first frame member rotatably attached to the first slide assembly at a first pivot joint. The frame of the door also includes a second frame member rotatably attached to the second slide assembly at a second pivot joint. The door is rotatable about the lateral direction at the first and second pivot joints between an inwardly tilted position in which the door defines an acute angle with the first and second slide assemblies and an outwardly tilted position in which the door defines an obtuse angle with the first and second slide assemblies.

In a second exemplary embodiment, a refrigerator appliance defining a lateral direction is provided. The refrigerator appliance includes a cabinet defining a chilled chamber and a first slide assembly mounted to the cabinet at least partially within the chilled chamber proximate to a first side of the refrigerator appliance along the lateral direction. The refrigerator appliance additionally includes a door including a frame having a first frame member rotatably attached to the first slide assembly at a first pivot joint such that the door is rotatable about the lateral direction at the first pivot joint. The first frame member is further attached to the first slide assembly at one or more first side attachment points such that the door is moveable along the lateral direction relative to the first slide assembly at the one or more first side attachment points.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, elevation view of a refrigerator appliance according to an exemplary embodiment of the present subject matter.

FIG. 2 provides a front, elevation view of the exemplary refrigerator appliance of FIG. 1 with refrigerator doors and a freezer door shown in an open position.

FIG. 3 provides a side cross-sectional view of a freezer chamber of the exemplary refrigerator appliance of FIG. 1 with the freezer door shown in a normal position.

FIG. 4 provides a side cross-sectional view of the freezer chamber of the exemplary refrigerator appliance of FIG. 1 with the freezer door shown in an inwardly tilted position.

FIG. 5 provides a side cross-sectional view of the freezer chamber of the exemplary refrigerator appliance of FIG. 1 with the freezer door shown in an outwardly tilted position.

FIG. 6 provides a side cross-sectional view of a freezer chamber of a refrigerator appliance in accordance with another exemplary embodiment of the present disclosure.

FIG. 7 provides a cross-sectional perspective view of one or more first side attachment points of the exemplary refrigerator appliance of FIG. 1.

FIG. 8 provides an overhead schematic view of certain components of the freezer chamber of the exemplary refrigerator appliance of FIG. 1 with the freezer door shown in a normal position.

FIG. 9 provides an overhead schematic view of certain components of the freezer chamber of the exemplary refrigerator appliance of FIG. 8 with the freezer door shown in a first side tilted position.

FIG. 10 provides an overhead schematic view of certain components of the freezer chamber of the exemplary refrigerator appliance of FIG. 8 with the freezer door shown in a second side tilted position.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

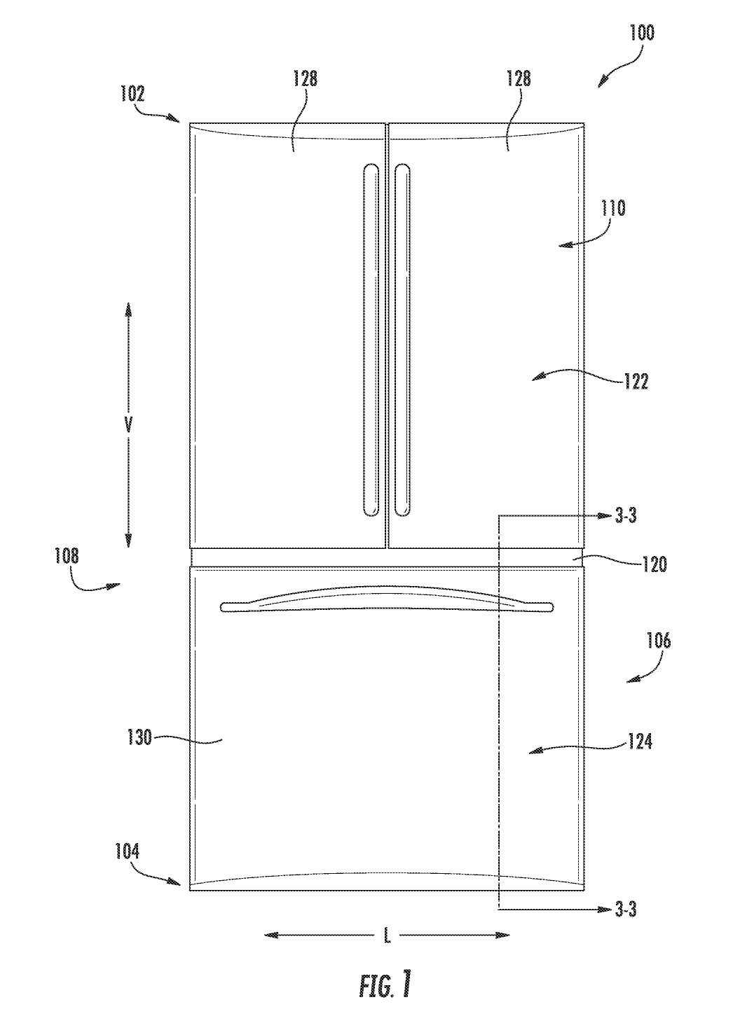

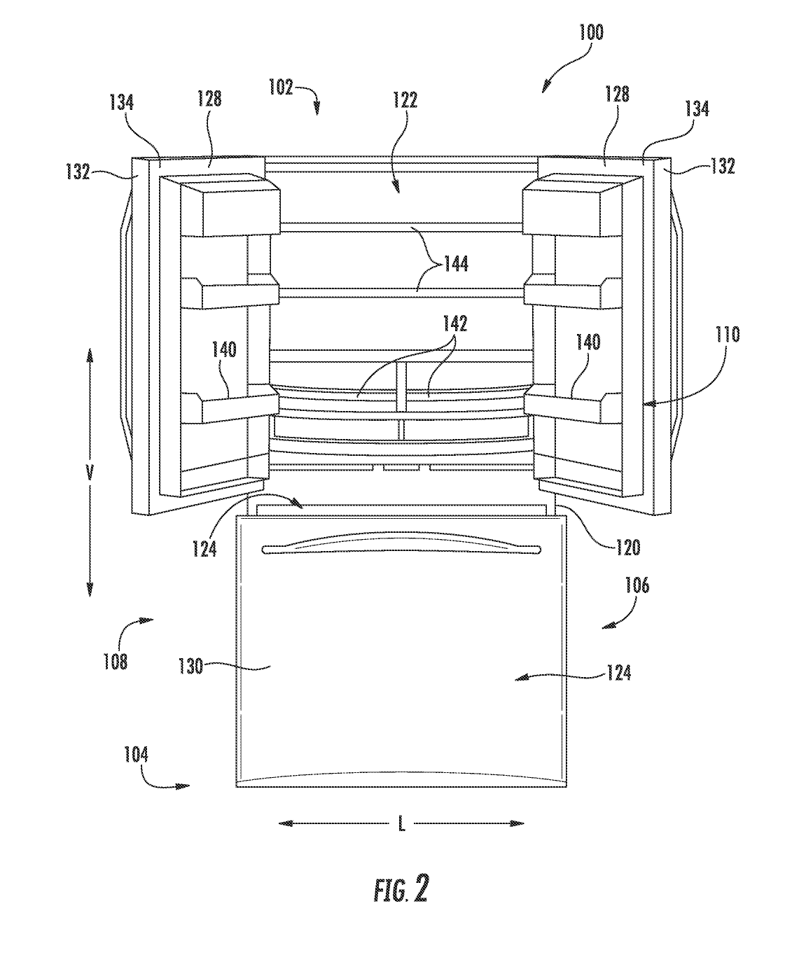

FIG. 1 provides a front, elevation view of a refrigerator appliance 100 according to an exemplary embodiment of the present subject matter with refrigerator doors 128 and freezer door 130 of the refrigerator appliance 100 shown in a closed position. FIG. 2 provides a front view of refrigerator appliance 100 with refrigerator doors 128 and freezer door 130 shown in an open position.

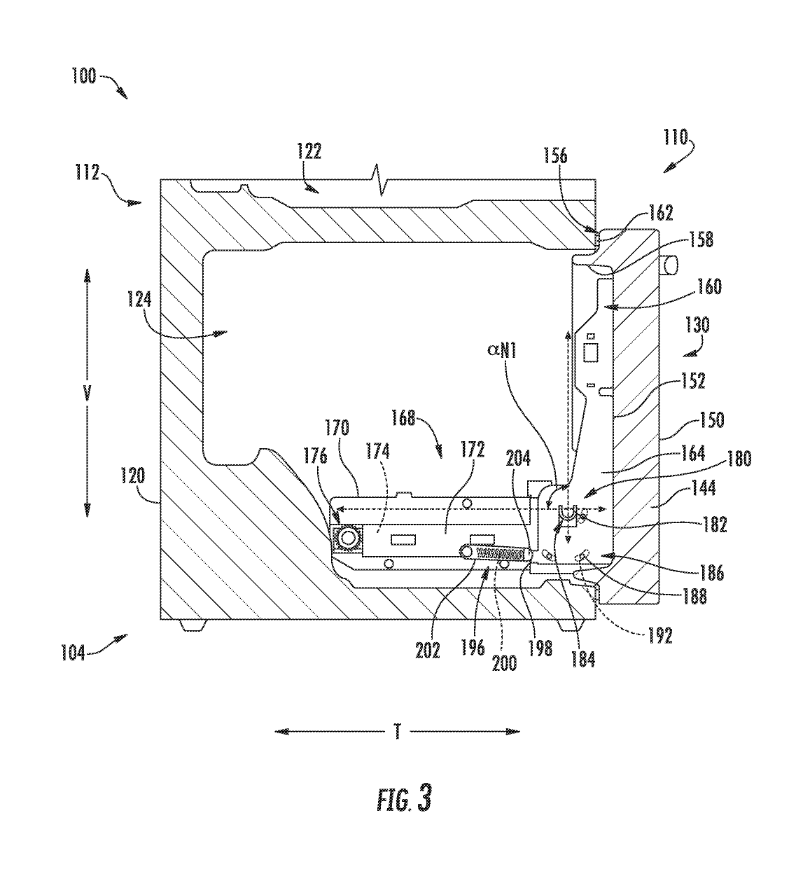

Refrigerator appliance 100 defines a vertical direction V, a lateral direction L, and a transverse direction T (see, e.g., FIG. 3), each mutually perpendicular to one another. Refrigerator appliance 100 includes a cabinet or housing 120 that extends between a top 102 and a bottom 104 along the vertical direction V, between a first side 106 and a second side 108 along the lateral direction L, and between a front side 110 and a rear side 112 along the transverse direction T. As depicted, cabinet 120 defines chilled chambers for receipt of food items for storage. In particular, cabinet 120 defines fresh food chamber 122 positioned at or adjacent top 102 of cabinet 120 and a freezer chamber 124 arranged at or adjacent bottom 102 of cabinet 120. As such, refrigerator appliance 100 is generally referred to as a bottom mount refrigerator.

Refrigerator doors 128 are rotatably hinged to an edge of cabinet 120 for selectively accessing fresh food chamber 122. In addition, a freezer door 130 is arranged below refrigerator doors 128 for selectively accessing freezer chamber 124. As is discussed in greater detail below, freezer door 130 is slidably mounted to cabinet 120 adjacent freezer chamber 124. Refrigerator doors 128 and freezer door 130 are shown in the closed position in FIG. 1, and refrigerator doors 128 and freezer door 130 are shown in the open position in FIG. 2. It should be appreciated, however, that in other exemplary embodiments, refrigerator appliance 100 may have any other suitable configuration. For example, in other exemplary embodiment, refrigerator appliance 100 may only include a single chilled chamber with a door slidably mounted adjacent thereto. Additionally, or alternatively, refrigerator appliance 100 may include refrigerator doors 128 slidably mounted adjacent to fresh food chamber 122.

Turning now to FIG. 2, various storage components are mounted within fresh food chamber 122 to facilitate storage of food items therein as will be understood by those skilled in the art. In particular, the storage components include bins 140, drawers 142, and shelves 144 that are mounted within fresh food chamber 122. Bins 140, drawers 142, and shelves 144 are configured for receipt of food items (e.g., beverages and/or solid food items) and may assist with organizing such food items. As an example, drawers 142 can receive fresh food items (e.g., vegetables, fruits, and/or cheeses) and increase the useful life of such fresh food items.

As also may be seen in FIG. 2, refrigerator doors 128 include outer panels 132 and inner liners 134. Each refrigerator door of refrigerator doors 128 includes a respective one of outer panels 132 and inner liners 134 mounted to each other. Insulation, such as sprayed polyurethane foam, may be disposed between outer panels 132 and inner liners 134 within refrigerator doors 128 in order to assist with insulating fresh food chamber 122 when refrigerator doors 128 are in the closed position. Outer panels 132 and inner liners 134 may be constructed of or with any suitable materials. For example, outer panels 132 may be constructed of or with a metal, such a stainless steel or painted steel, and inner liners 134 may be constructed of or with a suitable plastic material.

Referring now generally to FIGS. 3 through 5, side cross-sectional views are provided of refrigerator appliance 100 taken along Line 3-3 in FIG. 1. As stated, freezer door 130 is slidably attached to cabinet 120 adjacent freezer chamber 124. Freezer door 130 includes an outer panel 150 and an inner liner 152, with a layer of insulation 154 therebetween. Outer panel 150 and inner liner 152 may be constructed of or with any suitable materials. For example, outer panel 150 may be constructed of or with a metal, such a stainless steel or painted steel, and inner liner 152 may be constructed of or with a suitable plastic material. Additionally, inner liner 152 of freezer door 130 includes a perimeter lip 156 and an inwardly extending flange 158 configured to fit within an opening 160 of freezer chamber 124. A perimeter gasket 162 is attached to perimeter lip 156 to form a seal with cabinet 120 around freezer chamber 124 when freezer door 130 in the closed position. Gasket 162 may be comprised of any suitable material, such as any suitable resilient material. For example, gasket 162 may be comprised of an elastomeric material such as rubber, or a foam material. Perimeter gasket 162 may assist insulated panel of freezer door 130 in forming a seal with cabinet 120 of refrigerator appliance 100.

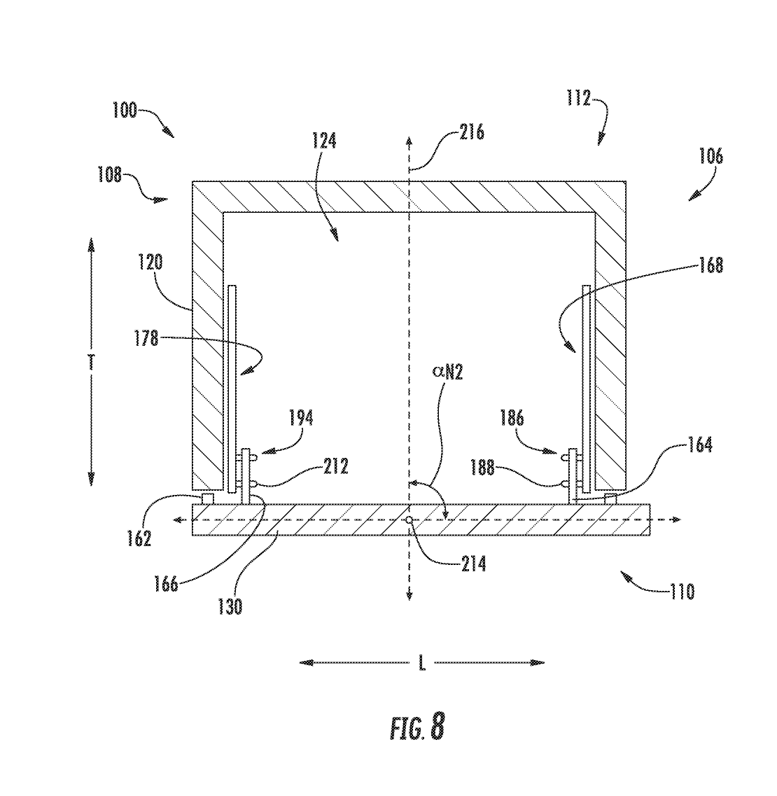

Further, freezer door 130 includes a frame having a first frame member 164 and a second frame member 166 (see FIG. 8). First frame member 164 and second frame member 166 may be part of a unified frame extending through freezer door 130, or alternatively may be individual members attached to, e.g., inner liner 152 of freezer door 130.

Refrigerator appliance 100 additionally includes a first slide assembly 168 mounted to cabinet 120 at least partially within freezer chamber 124 proximate to first side 106 of refrigerator appliance 100 along the lateral direction L. As used in this context, “proximate” refers to being closer to first side 106 than to second side 108. First slide assembly 168 generally includes an outer bracket 170, an inner bracket 172, and one or more slides 174 positioned therebetween. For the embodiment depicted, outer bracket 170 is attached directly to cabinet 120 of refrigerator appliance 100 within freezer chamber 124 and inner bracket 172 is slidably connected to outer bracket 170 via the one or more slides 174. However, in other embodiments, first slide assembly 168 may have any other suitable configuration. First slide assembly 168 is oriented such that first slide assembly 168 moves along the transverse direction T. More particularly, first slide assembly 168 is oriented such that inner bracket 172 of first slide assembly 168 moves along the transverse direction T relative to outer bracket 170.

First slide assembly 168 includes a first slide biasing member 176 to bias the freezer door 130 towards the closed position. Slide biasing member 176 may therefore exert a force on inner bracket 172 along the transverse direction T towards the inside of freezer chamber 124. In certain embodiments, first slide biasing member 176 may not act on inner bracket 172 until inner bracket 172 is positioned proximate to a closed position. For example, first slide biasing member 176 may not act on inner bracket 172 until inner bracket 172 is at least about seventy percent closed, such as at least about eighty percent closed, such as at least about ninety percent closed. Additionally, for the embodiment depicted, slide biasing member 176 is a spring-loaded gear that mechanically interacts with inner bracket 172 and/or the one or more slides 174. However, in other exemplary embodiments, any other suitable slide biasing member 176 may be provided, or alternatively no slide biasing member 176 may be provided. For example, in other exemplary embodiments, slide biasing member 176 may include a dampening system.

Refrigerator appliance 100 additionally includes a second slide assembly 178 (see FIG. 8) mounted to cabinet 120 at least partially within freezer chamber 124 proximate to second side 108 of refrigerator appliance 100 along the lateral direction L. More particularly, second slide assembly 178 may be mounted to the cabinet 120 at least partially within the chilled chamber at a position opposite the first slide assembly 168 along the lateral direction L. Second slide assembly 178 may be configured in substantially the same manner as first slide assembly 168, or alternatively may be configured in any other suitable manner. For example, second slide assembly 178 may similarly be oriented such that second slide assembly 178 moves along the transverse direction T, or more particularly, such that an inner bracket of second slide assembly 178 moves along the transverse direction T relative to an outer bracket of second slide assembly 178. Moreover, second slide assembly 178 may similarly include a second slide biasing member configured in substantially the same manner as first slide biasing member 176.

In certain embodiments, a basket or drawer (not shown) may be attached to and extend between inner bracket 172 of first slide assembly 168 and the inner bracket of second slide assembly 178. Accordingly, when freezer door 130 is moved to the open position, such a basket or drawer may be exposed and accessible to a user.

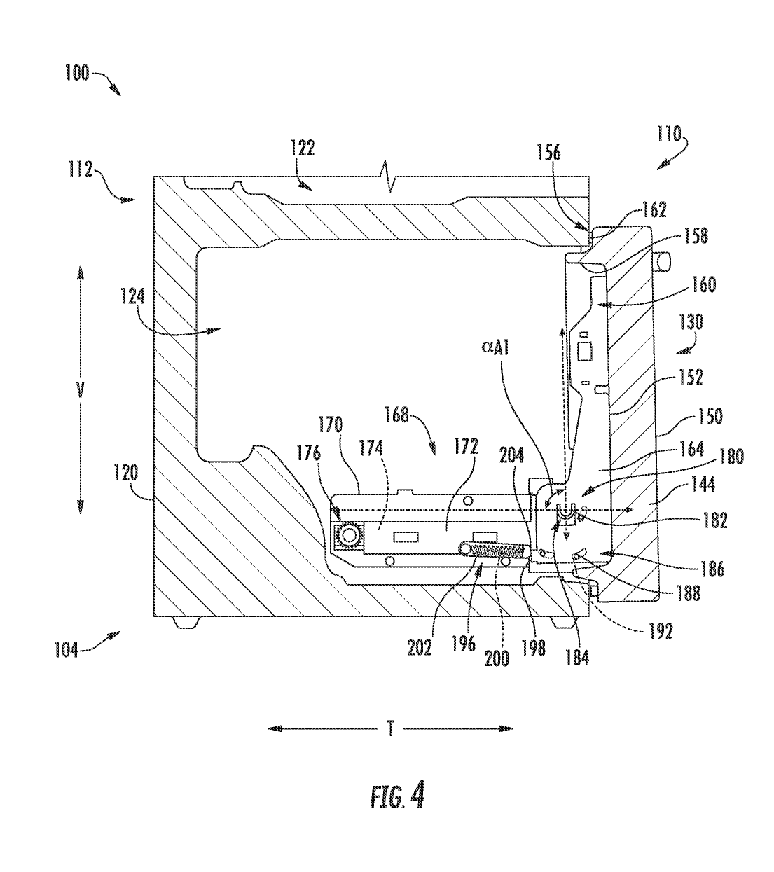

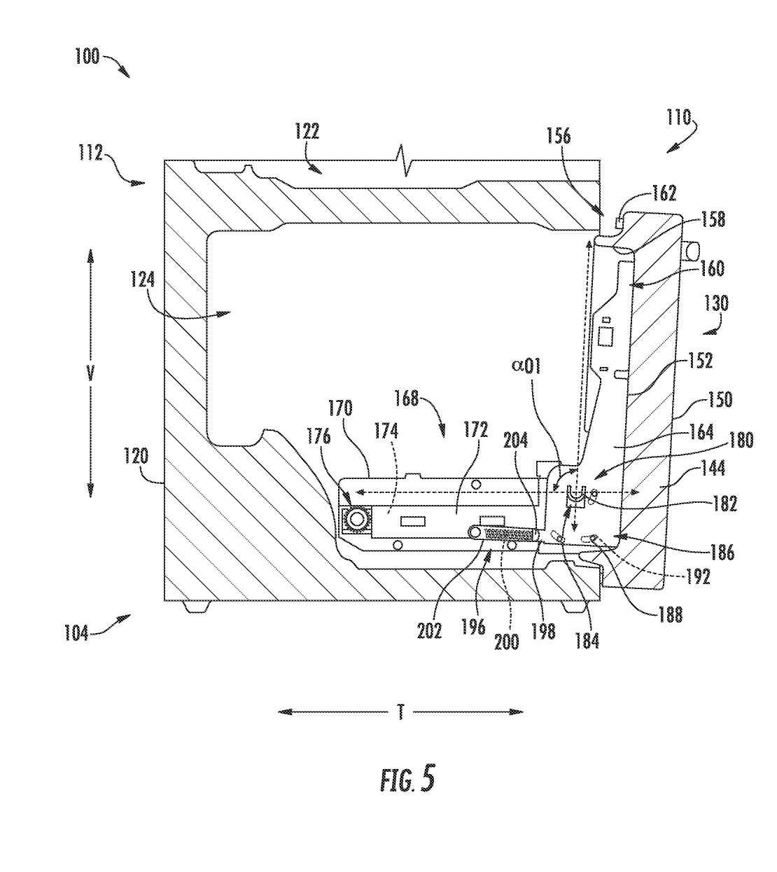

Referring still to FIGS. 3 through 5, first frame member 164 is rotatably attached to first slide assembly 168 at a first pivot joint 180. For the embodiment depicted, first frame member 164 includes a downwardly extending knob 182 received into a correspondingly shaped channel 184 defined by first slide assembly 168. Additionally, second frame member 166 of the frame of freezer door 130 may also be rotatably attached to the second slide assembly 178 at a second pivot joint (not shown). Accordingly, with such a configuration, freezer door 130 is rotatable about the lateral direction L at first pivot joint 180 and the second pivot joint between an inwardly tilted position (FIG. 4) in which freezer door 130 defines an acute angle α_{A1} with first and second slide assemblies 168, 178 and an outwardly tilted position (FIG. 5) in which freezer door 130 defines an obtuse angle α_{O1} with first and second slide assemblies 168, 178.

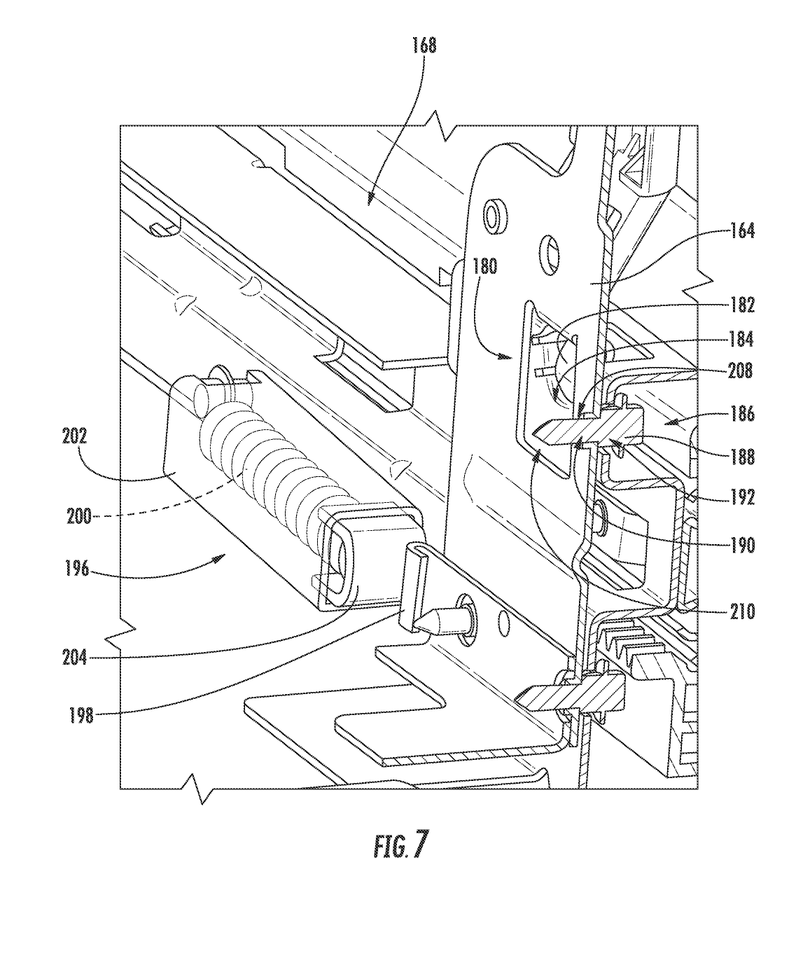

First frame member 164 is further attached to first slide assembly 168 at one or more first side attachment points 186 using one or more respective first side bolts 188. Each of the one or more first side attachment points 186 includes a first frame member opening 190 (see FIG. 7) defined in first frame member 164 and a first slide assembly opening 192 (shown in phantom) defined in first slide assembly 168, or more particularly, defined in inner bracket 172 of first slide assembly 168. One or both of first frame member opening 190 and first slide assembly opening 192 is an elongated opening having a length allowing for freezer door 130 to move between the inwardly tilted position (FIG. 4) and the outwardly tilted position (FIG. 5). More specifically, the elongated opening(s) have a length in a circumferential direction relative to first pivot joint 180 allowing for freezer door 130 to rotate between the inwardly tilted position (FIG. 4) and the outwardly tilted position (FIG. 5). Accordingly, the one or more first side attachment points 186 may act as stops for freezer door 130, constraining movement of freezer door 130 between the inwardly tilted position (FIG. 4) and the outwardly tilted position (FIG. 5). For the embodiment depicted, first slide assembly openings 192 are configured as elongated openings, however in other exemplary embodiments, first frame member openings 190 may additionally or alternatively be configured as elongated openings. It should be appreciated that second frame member 166 may similarly be further attached to second slide assembly 178 at one or more second side attachment points 194 (see FIG. 8) configured in a substantially similar manner to first side attachment points 186.

Referring specifically to FIG. 3, freezer door 130 is shown in a “normal” closed position with freezer door 130 defining a normal angle α_{N1} with first slide assembly 168, which for the embodiment depicted is 90 degrees. By contrast, referring now to FIG. 4, freezer door 130 is shown in the inwardly tilted position such that freezer door 130 defines acute angle α_{A1} with first slide assembly 168 and second slide assembly 178. For the embodiment depicted, acute angle α_{A1} defined by freezer door 130 with first slide assembly 168 may be between eighty degrees and eighty-nine degrees, such as between eighty-five degrees and eighty-eight and one half degrees, such as between eighty-six degrees and eighty-eight degrees. Additionally, referring now particularly to FIG. 5, freezer door 130 is shown in the outwardly tilted position such that freezer door 130 defines obtuse angle α_{O1} with first slide assembly 168 and second slide assembly 178. For the embodiment depicted, obtuse angle α_{O1} defined by freezer door 130 with first slide assembly 168 and second slide assembly 178 may be between ninety-one degrees in one hundred degrees, such as between ninety-one and one half degrees and ninety-eight degrees, such as between ninety-two degrees and ninety-five degrees.

For the embodiment depicted, refrigerator appliance 100 further includes a first biasing member 196 extending between first frame member 164 and first slide assembly 168. First biasing member 196 is depicted attached to inner bracket 172 of first slide assembly 168 and exerting a force against a nub 198 defined by first frame member 164. First biasing member 196 depicted biases freezer door 130 towards the inwardly tilted position (FIG. 4). More particularly, first biasing member 196 generates a moment on first pivot joint 180. It should be appreciated, that the moment generated on first pivot joint 180 may urge freezer door 130 slightly away from the closed position (i.e., may press a top of inner liner 152 of freezer door 130 against cabinet 120, potentially pulling a bottom of freezer door 130 away from cabinet 120). However, as previously stated, first slide biasing member 176 may be configured to generate a closing force on inner bracket 172 of first slide assembly 168. For the embodiment depicted, the closing force generated by the slide biasing 176 member may overcome any urging of freezer door 130 away from the closed position by first biasing member 196.

For the embodiment depicted, first biasing member 196 includes a spring 200 contained within a cylindrical member 202, the cylindrical member 202 attached to inner bracket 172 of first slide assembly 168. Spring 200 includes a cap 204 at an end that extends through cylindrical member 202. Cap 204 is configured to press against nub 198 of first frame member 164.

Additionally, refrigerator appliance 100 may further include a second biasing member (not shown) extending between and second frame member 166 and second slide assembly 178 (see FIG. 8). Second biasing member may be configured in substantially the same manner as first biasing member 196.

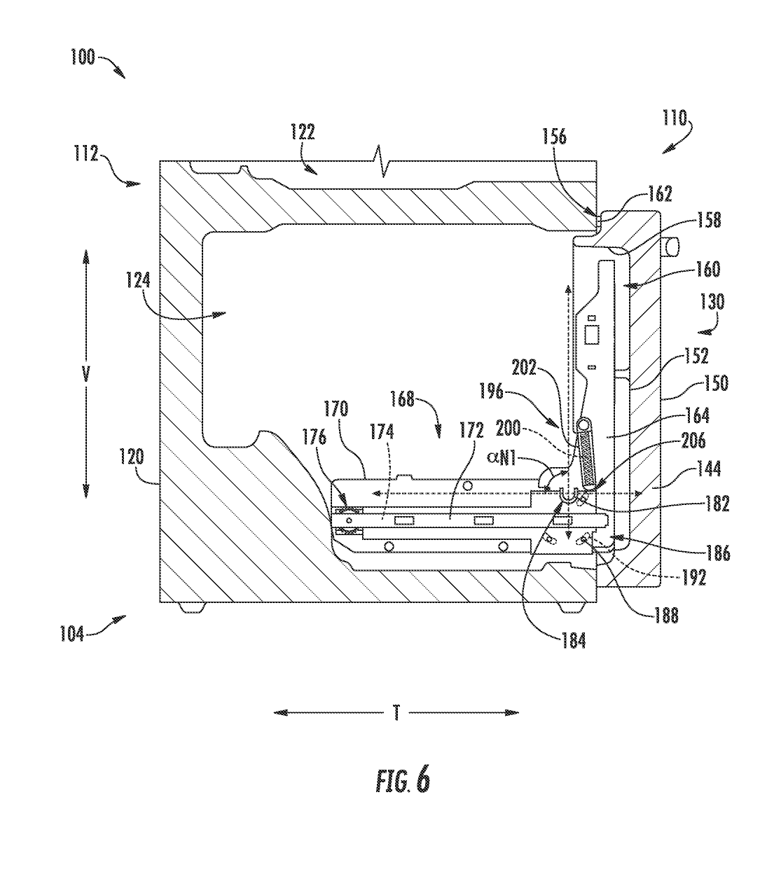

Referring now briefly to FIG. 6, it should be appreciated that in other exemplary embodiments, refrigerator appliance 100 may include any other suitable configuration for biasing freezer door 130 towards the inwardly tilted position. For example, FIG. 6 provides a side cross-sectional view of a refrigerator appliance 100 in accordance with another exemplary embodiment. The exemplary refrigerator appliance 100 of FIG. 6 may be configured in substantially the same manner as the exemplary refrigerator appliance 100 of FIGS. 3 through 5. However, for the embodiment of FIG. 6, first biasing member 196 is instead attached to first frame member 164 and abuts a nub 206 positioned on first slide assembly 168, or more particularly, on inner bracket 172 of first slide assembly 168. It should also be appreciated, however, that in still other exemplary embodiments, first biasing member 196 and/or second biasing member may include any other suitable configuration. For example, the first biasing member 196 and/or second biasing member may be configured as a hydraulic biasing member, or alternatively may include a portion made of a resilient material positioned to provide the desired biasing forces.

Referring back to FIGS. 3 through 5, freezer door 130 should define the normal angle α_{A1} with first slide assembly 168 and second slide assembly 178 in the closed position during optimal conditions—e.g., when cabinet 120 defines little or no surface variations; when first slide assembly 168, second slide assembly 178, and freezer door 130 are properly installed; and when perimeter gasket 162 defines a consistent shape/thickness. In less than optimal conditions however—e.g., when cabinet 120 has been damaged during shipping, installation, or otherwise such that cabinet 120 defines surface variations surrounding freezer chamber 124; when one or more of first slide assembly 168, second slide assembly 178, and freezer door 130 have not been properly aligned during installation; and/or when perimeter gasket 162 becomes worn down or defines variations in its thickness—freezer door 130 may not form a desired seal with cabinet 120 when positioned at the normal angle α_{A1} with first slide assembly 168. Accordingly, a freezer door 130 in accordance with the present disclosure may automatically adjust, i.e. self-adjust, to the inwardly tilted position (FIG. 4) or the outwardly tilted position (FIG. 5), or any position therebetween, to accommodate such surface variations, improper component installation, and/or imperfections or inconsistencies in perimeter gasket 162 to form a more complete seal with cabinet 120.

Referring now to FIG. 7, a perspective, cross-sectional view of first frame member 164 and first slide assembly 168 is provided. More particularly, a perspective cross-sectional view of the one or more first side attachment points 186 is provided. As shown, the one or more first side bolts 188 each define a shoulder 208, i.e., a smooth cylindrical portion, extending through the respective first frame member openings 190. Accordingly, freezer door 130 is movable along the lateral direction L relative to first slide assembly 168. Additionally, as is shown, the channel 184 defined by first slide assembly 168 into which the downwardly facing knob 182 of first frame member 164 is received defines a length along the lateral direction L such that the first pivot joint 180 may accommodate movement of freezer door 130 along the lateral direction L relative to first slide assembly 168, as well as movement about the lateral direction L relative to first slide assembly 168.

Although for the embodiment depicted the one or more first side bolts 188 include a tipped/pointed end 210, which may assist with installation, in other embodiments, tipped end 210 may instead define a threaded portion configured to receive a correspondingly threaded nut. It should also be appreciated that second side attachment points 194 may be configured in substantially the same manner. For example, second side frame member 166 may be further attached to second slide assembly 178 at the one or more second side attachment points 194 using one or more respective second side bolts 212 (see FIG. 8). The one or more second side bolts 212 may similarly define a shoulder such that freezer door 130 is movable along the lateral direction L relative to second slide assembly 178. Additionally, second pivot joint may be configured in the same manner as first pivot joint 180 such that second pivot joint 180 also accommodates movement of freezer door 130 along the lateral direction L relative to second slide assembly 178 and movement about the lateral direction L relative to second slide assembly 178.

Referring now to FIGS. 8 through 10, schematic views are provided of a freezer chamber 124 of the refrigerator appliance 100 of FIG. 1. More particularly, FIGS. 8 through 10 provide a top, cross-sectional view of certain components of cabinet 120 and freezer door 130 through freezer chamber 124. As depicted, movement of freezer door 130 along the lateral direction L relative to the first slide assembly 168 and second slide assembly 178 essentially allows for freezer door 130 to rotate slightly about the vertical direction V at a center point 214 of freezer door 130. Center point 214 is a halfway point of the freezer door 130 along the lateral direction L.

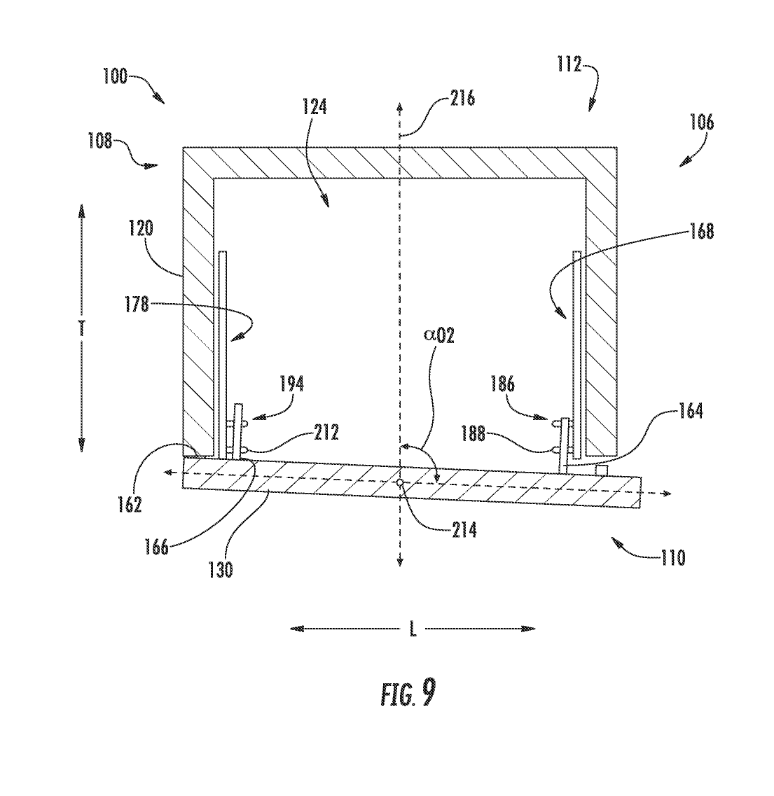

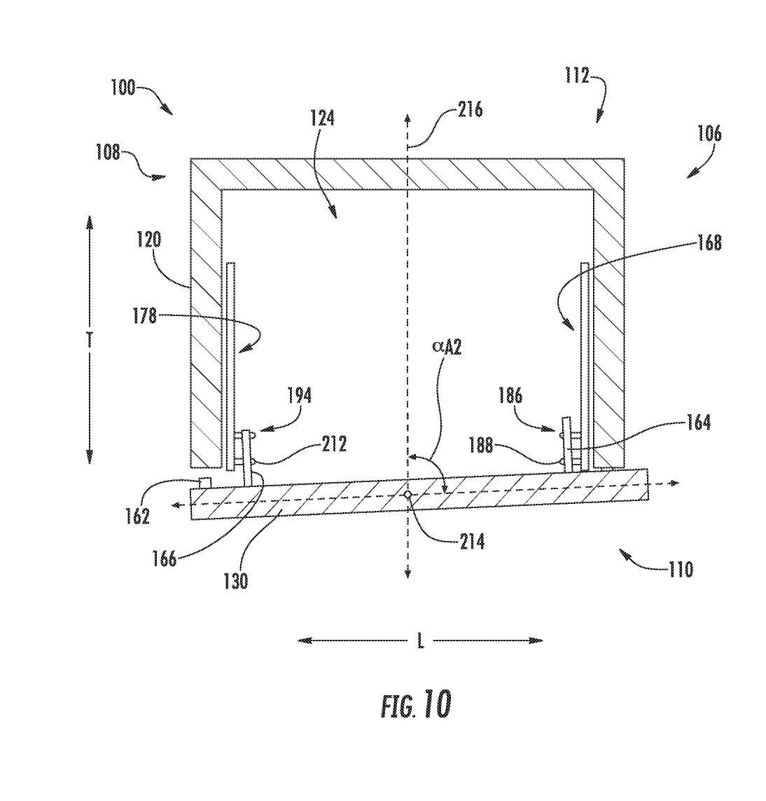

Referring particularly to FIG. 8, freezer door 130 is shown schematically in a “normal” closed position relative to cabinet 120, defining an angle α_{N2} of ninety degrees with first and second slide assemblies 168, 178 and a transverse centerline 216 of refrigerator appliance 100. Transverse centerline 216 extends along the transverse direction T through center point 214, and accordingly may be parallel to first and second slide assemblies 168, 178. By contrast, referring now particularly to FIG. 9, freezer door 130 shown schematically in a first side tilted position in which freezer door 130 defines an acute angle α_{A2} with transverse centerline 216 of refrigerator appliance 100. Additionally, referring now particularly to FIG. 10, freezer door 130 is shown schematically in a second side tilted position in which freezer door 130 defines an obtuse angle α_{O2} with transverse centerline of refrigerator appliance 100. Movement of freezer door 130 between first side tilted position, normal position, and second side tilted position is allowed due to the configuration of the one or more first side attachment points 186, as well as the one or more second side attachment points 194. As stated, second side attachment points 194 may be configured in substantially the same manner as first side attachment points 186.

A refrigerator appliance 100 in accordance with an exemplary embodiment of the present disclosure including a freezer door 130 that is rotatable about the lateral direction L and movable along the lateral direction L relative to the first slide assembly 168 and the second slide assembly 178 (such that freezer door 130 is also rotatable about the vertical direction V) may allow for a more complete seal with cabinet 120. More particularly, such a self-adjusting freezer door 130 may allow for a more complete seal with cabinet 120 despite, e.g., any service variations of cabinet 120, miss installation of certain components, and/or perimeter gasket 162 inconsistencies.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A refrigerator appliance defining a lateral direction, the refrigerator appliance comprising:
a cabinet defining a chilled chamber;
a first slide assembly mounted to the cabinet at least partially within the chilled chamber;
a second slide assembly mounted to the cabinet at least partially within the chilled chamber at a position opposite the first slide assembly along the lateral direction; and
a door including a frame having a first frame member rotatably attached to the first slide assembly at a first pivot joint and a second frame member rotatably attached to the second slide assembly at a second pivot joint, the door rotatable about the lateral direction at the first and second pivot joints between an inwardly tilted position in which the door defines an acute angle with the first and second slide assemblies, a closed position in which the door defines a normal angle with the first and second slide assemblies, and an outwardly tilted position in which the door defines an obtuse angle with the first and second slide assemblies.

2. The refrigerator appliance of claim 1, further comprising
a first biasing member extending between the first frame member and the first slide assembly, the first biasing member biasing the door towards the inwardly tilted position and urging the door away from the closed position.

3. The refrigerator appliance of claim 2, wherein the first biasing member includes a spring.

4. The refrigerator appliance of claim 1, wherein the refrigerator appliance defines a transverse direction, wherein the door is moveable between an open position and a closed position along the transverse direction, and wherein the door includes a perimeter gasket configured to form a seal with the cabinet around the chilled chamber when in the closed position.

5. The refrigerator appliance of claim 2, wherein the first slide assembly includes a slide biasing member, the slide biasing member configured to generate a closing force for biasing the door towards the closed position, and wherein the closing force generated by the slide biasing member is configured to overcome the urging of the door away from the closed position by the first biasing member.

6. The refrigerator appliance of claim 1, wherein the acute angle defined by the door with the first and second slide assemblies is between eighty degrees and eighty-nine degrees.

7. The refrigerator appliance of claim 1, wherein the obtuse angle defined by the door with the first and second slide assemblies is between ninety-one degrees and one hundred degrees.

8. The refrigerator appliance of claim 1, wherein the first frame member is further attached to the first slide assembly at one or more first side attachment points using one or more respective first side bolts, wherein each of the one or more the first side attachment points includes a first frame member opening and a first slide assembly opening, and wherein one or both of the first frame member opening and the first slide assembly opening is an elongated opening having a length allowing for the door to move between the inwardly tilted position and outwardly tilted position.

9. The refrigerator appliance of claim 1, wherein the first frame member is further attached to the first slide assembly at one or more first side attachment points using one or more respective first side bolts, wherein the one or more first side bolts each define a shoulder such that the door is moveable along the lateral direction relative to the first slide assembly.

10. The refrigerator appliance of claim 9, wherein the second frame member is further attached to the second slide assembly at one or more second side attachment points using one or more respective second side bolts, wherein the one or more second side bolts each define a shoulder such that the door is moveable along the lateral direction relative to the second slide assembly.

11. A refrigerator appliance defining a lateral direction, the refrigerator appliance comprising:
a cabinet defining a chilled chamber;
a first slide assembly mounted to the cabinet at least partially within the chilled chamber proximate to a first side of the refrigerator appliance along the lateral direction, the first slide assembly including a slide biasing member configured to generate a closing force for biasing the door towards the closed position;
a door including a frame having a first frame member rotatably attached to the first slide assembly at a first pivot joint such that the door is rotatable about the lateral direction at the first pivot joint between an inwardly tilted position in which the door defines an acute angle with the first slide assembly and a closed position in which the door defines a normal angle with the first slide assembly; and
a first biasing member extending between the first frame member and the first slide assembly, the first biasing member biasing the door towards the inwardly tilted position and urging the door away from the closed position, wherein the closing force generated by the slide biasing member is configured to overcome the urging of the door away from the closed position by the first biasing member.

12. The refrigerator appliance of claim 11, wherein the first frame member is further attached to the first slide assembly at one or more first side attachment points such that the door is moveable along the lateral direction relative to the first slide assembly at the one or more first side attachment points, wherein the first frame member is attached to the first slide assembly at the one or more first side attachment points using one or more first side bolts, wherein each of the one or more first side bolts defines a shoulder, wherein each of the one or more the first side attachment points includes a first frame member opening and a first slide assembly opening, and wherein one or both of the first frame member opening and first slide assembly opening are slidable along the shoulder of the respective first side bolt.

13. The refrigerator appliance of claim 11, wherein the door is further rotatable about the lateral direction at the pivot joint between the inwardly tilted position and an outwardly tilted position in which the door defines an obtuse angle with the slide assembly.

14. (canceled)

15. The refrigerator appliance of claim 11, wherein the acute angle defined by the door with the slide assembly is between eighty degrees and eighty-nine degrees.

16. The refrigerator appliance of claim 13, wherein the obtuse angle defined by the door with slide assembly is between ninety-one degrees and one hundred degrees.

17. The refrigerator appliance of claim 13, wherein one or both of the first frame member opening and the first slide assembly opening is an elongated opening having a length allowing for the door to move between the inwardly tilted position and outwardly tilted position.

18. The refrigerator appliance of claim 11, wherein the refrigerator appliance defines a transverse direction, wherein the door is moveable between an open position and a closed position along the transverse direction, and wherein the door includes a perimeter gasket configured to form a seal with the cabinet around the chilled chamber when in the closed position.

19. (canceled)

20. The refrigerator appliance of claim 11, further comprising
a second slide assembly mounted to the cabinet at least partially within the chilled chamber proximate a second side of the cabinet along the lateral direction, wherein the frame of the door further includes a second frame member rotatably attached to the second slide assembly at a second pivot joint.
